(19) United States
(12) Patent Application Publication
(10) Pub. No.: US 2003/0220083 A1
(43) Pub. Date: Nov. 27, 2003

(54) High frequency composite component

(75) Inventors: Chang Yong Lee, Sungnam (KR); Yu Seon Shin, Gwacheon (KR); Jong Ik Lee, Seoul (KR)

Correspondence Address: LOWE HAUPTMAN GOPSTEIN GILMAN & BERNER, LLP, Suite 310, 1700 Diagonal Road, Alexandria, VA, 22314, US

(73) Assignee: Samsung Electro-Mechanics Co., Ltd.

(21) Appl. No.: 10/419,774

(22) Filed: Apr. 22, 2003

(30) Foreign Application Priority Data
May 27, 2002 (KR) 2002-29238
Jan. 27, 2003 (KR) 2003-5178

(51) Int. Cl. H04B 1/00

(52) U.S. Cl. 455/130; 455/154.1

(57) ABSTRACT

Disclosed is a high frequency composite component formed of a single module comprising a surface acoustic wave (SAW) duplexer and a diplexer in a front-end portion for processing a high frequency signal between a transmitting/receiving unit and an antenna of a high frequency circuit of a dual band mobile communication terminal, thereby improving characteristics such as reducing insertion loss and satisfying the miniaturization of the mobile communication terminal. The diplexer is formed of a conductive pattern on a plurality of dielectric sheets of a laminated structure, and the SAW duplexer includes two SAW filters mounted on a cavity of the laminated structure and a phase shifting device formed as a conductive pattern on a dielectric sheet of the laminated structure.

### BACKGROUND OF THE INVENTION

1. Field of the Invention

The present invention relates to a high frequency composite component, and more particularly to a high frequency composite component formed of a single module comprising a surface acoustic wave (SAW) duplexer and a diplexer in a front-end portion for processing a high frequency signal between a transmitting/receiving unit and an antenna of a high frequency circuit of a dual band mobile communication terminal, thereby improving characteristics such as reducing insertion loss, and satisfying the miniaturization of the mobile communication terminal.

2. Description of the Related Art

Recently, a tendency of mobile communication terminals has been toward multi-functionalization. In order to satisfy this multi-functional trend, a dual band terminal has been developed. The dual band terminal can simultaneously transmit and receive two different frequency band signals via a single antenna. For example, a mobile communicaiton terminal for simultaneous transmitting and receiving signals at a CDMA frequency band (approximately 824-894 NHz) and a PCS frequency band (approximately 1,850-1,990 MHz) using one antenna has been developed.

With reference to FIG. 1, a configuration of a front-end portion of a conventional dual band mobile communication terminal using the CDMS frequency band (as a low frequency band) and the PCS frequency band (as a high frequency band) is described in detail.

FIG. 1 is a block diagram of the front-end portion 10 of the conventional dual band mobile communication terminal. The front-end portion 10 of the conventional dual band mobile communication terminal comprises a diplexer 11, a duplexer 12 being used at the CDMA frequency band, and another duplexer or a high frequency switch 13 used at the PCS frequency band.

The diplexer 11 serves to distribute a signal received via an antenna ANT to a CDMA system or a PCS system and to transfer a signal transmitted from the CDMA or PCS system to the antenna ANT. The CDMA system comprises the duplexer 12. The duplexer 12 serves to divide the CDMA system into a receiving unit Rxc and a transmitting unit Txc, and to transfer a signal received from the diplexer 11 to the receiving unit Rxc and to transfer a signal received from the transmitting unit Txc of the CDMA system to the diplexer 11. The PCS system comprises another duplexer or the high frequency switch 13. The duplexer or the high frequency switch 13 of the PCS system serves to divide the PCS system into a receiving unit Rxp and a transmitting unit Txp, and to transfer a signal received from the diplexer 11 to the receiving unit Rxp of the PCS system and to transfer a signal received from the transmitting unit Txp of the PCS system to the diplexer 11.

As described above, the diplexer, the duplexer and the high frequency switch are separately formed within the front-end portion of the dual band mobile communication terminal. Compared to a single band mobile communication terminal, this conventional configuration of the front-end portion of the dual band mobile communication terminal requires a larger number of components and matching circuits for electrically connecting the components, thereby increasing insertion loss most affecting electrical characteristics of the mobile communication terminal and deteriorating speech qualities of the mobile communication terminal. A space for mounting the components is required within the front-end portion of the conventional dual band mobile communication terminal, thereby increasing the size of the mobile communication terminal and lowering the portability of the mobile communication terminal.

Accordingly, a new high frequency component, which satisfies the miniaturization and lightweight trends of the dual band mobile communication terminal, and has more excellent characteristics such as low insertion loss, has been demanded.

### SUMMARY OF THE INVENTION

Therefore, the present invention has been made in view of the above problems, and it is an object of the present invention to provide a high frequency composite component formed of a single module comprising a diplexer and a duplexer within a front-end portion of a dual band mobile communication terminal, thereby reducing the number of components of the front-end portion of the mobile communication terminal, shortening a signaling path, and reducing the size of the front-end portion.

It is another object of the invention to provide a composite module structure in order to prevent signal loss owing to separate connection of a composite module to a second communication system in unifying a diplexer and a duplexer into one composite module or a single component

According to an aspect of the invention for realizing the above objects, the invention provides a high frequency composite component formed in a front-end portion of a mobile communication terminal, which includes a first communication system passing through a first frequency band and a second communication system passing through a second frequency band higher than the first frequency band. The high frequency composite component comprises: a Surface Acoustic Wave (SAW) duplexer connected to the first communication system and serving to divide signals into transmitting and receiving signals at the first frequency band; and a diplexer connected to an antenna, the SAW duplexer and the second communication system, and serving to divide signals received from the antenna into signals at the first frequency band and signals at the second frequency band, to provide the divided signals respectively to the SAW duplexer and the second communication system, and to transfer signals provided by the SAW duplexer and transmitted from the first communication system and signals transmitted from the second communication system to the antenna.

According to another aspect of the invention for realizing the above objects, the invention provides a laminated high frequency composite component formed in a front-end portion of a mobile communication terminal, which includes a first communication system for processing a first frequency band and a second communication system for processing a second frequency band higher than the first frequency band. The laminated high frequency composite component comprises: a lower laminated structure formed by stacking a plurality of dielectric sheets; an upper laminated structure having a cavity area in its center and formed on the lower laminated structure by stacking a plurality of dielectric sheets; a diplexer formed of a conductive pattern on at least parts of the dielectric sheets of the lower and/or upper laminated structure; a Surface Acoustic Wave (SAW) duplexer mounted on the upper surface of the lower laminated structure defined by the cavity area; and a protective sheet formed on the upper surface of the upper laminated structure and serving to seal the cavity areas.

According to yet another aspect of the invention for realizing the above objects, the invention provides a laminated high frequency composite component formed in a front-end portion of a mobile communication terminal, which includes a first communication system for processing a first frequency band and a second communication system for processing a second frequency band higher than the first frequency band. The laminated high frequency composite component comprises: a laminated structure having a plurality of laminated dielectric sheets with a cavity area on its center, the laminated dielectric sheets forming a diplexer and including a first frequency pass filter layer, a pair of ground sheets each having an open area, and a second frequency pass filter layer laminated between the ground sheets and having a plurality of capacitance elements formed of conductive patterns in positions corresponding to the open areas and at least one strip line for connecting the capacitance elements; a Surface Acoustic Wave (SAW) duplexer mounted within the cavity area of the laminated structure; and a protective sheet disposed on the laminated structure for sealing the cavity area.

It is preferred that the laminated structure includes a first signal port connected to an antenna and a second signal port connected to second communication system, wherein the first signal port for the antenna and the second signal port for the second communication system are opposite to each other. Also preferably, the capacitance elements of the second frequency pass filter layer includes a first capacitance element disposed adjacent to the signal port for the antenna and a second capacitance element disposed adjacent to the second communication system, and wherein the strip line connects between the first and second capacitance elements.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a front-end portion of a conventional dual band mobile communication terminal;

FIG. 2 is a block diagram showing a configuration of a high frequency composite component in accordance with the present invention;

FIG. 3 is an exploded perspective view showing a laminated structure comprising individual dielectric sheets in accordance with an embodiment of the present invention;

FIG. 4a is a cross-sectional view of a high frequency composite component in accordance with the embodiment of the present invention;

FIG. 4b is an elevation view of the high frequency composite component in accordance with the embodiment of the present invention; and

FIG. 5 is an equivalent circuit diagram of the high frequency composite component in accordance with the embodiment of the present invention.

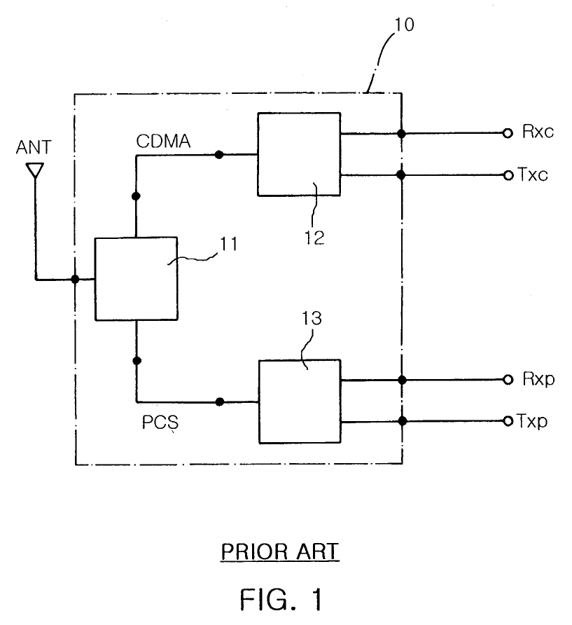

### DETAILED DESCRIPTION OF THE PREFERRED EMBODIMENT

The following detailed description will present a preferred embodiment of the invention in reference to the accompanying drawings.

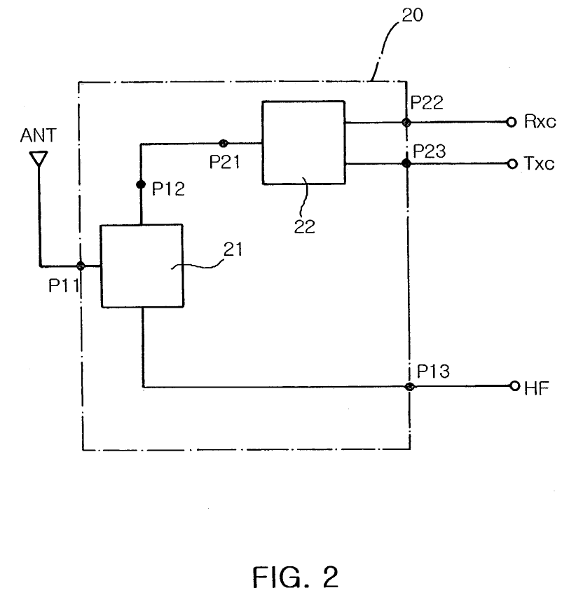

FIG. 2 is a block diagram partially showing a front-end portion of a dual band mobile communication terminal using a high frequency composite component 20 of the present invention. The high frequency composite component 20 of the present invention comprises a diplexer 21 and a Surface Acoustic Wave (SAW) duplexer 22.

The diplexer 21 serves to distribute a signal received via an antenna ANT to a first communication system or a second communication system and to transfer a signal transmitted from the first or second communication system to the antenna ANT. The SAW duplexer 22 serves to divide the first communication system into a receiving unit Rxc and a transmitting unit Txc, and to transfer a signal received from the diplexer 21 to the receiving unit Rxc and to transfer a signal received from the transmitting unit Txc to the diplexer 21. The SAW duplexer 22 comprises two SAW filters and a phase shifting device. Since the SAW filter of the SAW duplexer 22 is not suitable for processing a high frequency exceeding 1 GHz, the first communication system using the SAW duplexer is preferably a CDMA system for processing signals at a first frequency band in a range of 824-894 MHz.

A first port P11 of the diplexer 21 is connected to the antenna ANT, and a second port P12 of the diplexer 21 is connected to a first port P21 of the SAW duplexer 22. A third port P13 of the diplexer 21 is connected to one terminal HF (High Frequency) of the second communication system. Herein, the second communication system processes signals at a second frequency band in a range higher than that of the first communication system.

The first port P21 of the SAW duplexer 22 is connected to the second port P12 of the diplexer 21, and a second port P22 of the SAW duplexer 22 is connected to the receiving unit Rxc of the first-communication system. A third port P23 of the SAW duplexer 22 is connected to the transmitting unit Txc of the first communication system.

In accordance with a preferred embodiment of the present invention, the first frequency band processed by the first communication system is in a range of approximately 824-894 MHz being used in the CDMA system, and the second frequency band processed by the second communication system is in a range of approximately 1,570-1,580 MHz being used in a GPS system or in a range of approximately 1,850-1,990 MHz being used in a PCS system.

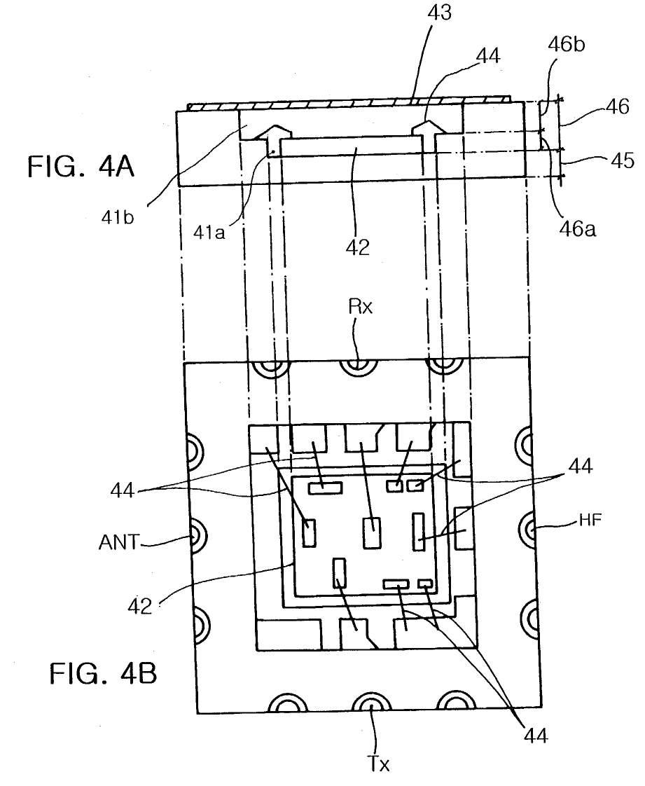

FIG. 4A is a cross-sectional view of the high frequency composite component in accordance with the preferred embodiment of the present invention. The laminated structure comprises a lower laminated structure 45 and an upper laminated structure 46 including the first and second laminated structures 46a and 46b. Two SAW filters 42 are mounted on an upper surface of the first laminated structure within the first and second cavities 41a and 41b. The two SAW filters 42 are connected to a conductive pattern of the second laminated structure by a wire bonding method using a wire 44. An upper surface of the second laminated structure is sealed by a protective sheet or passivation sheet 43, and planarized. Preferably, the passivation sheet 43 is made of metal. The metal-made passivation sheet 43 serves to stabilize the characteristics of the SAW filters in the cavity and to protect the SAW filters and the wire-bonding structure while allowing a module having the laminated structures to be easily handled.

FIG. 4B is an elevation view of the high frequency composite component in accordance with the preferred embodiment of the present invention. Two SAW filters 42 are mounted as one chip type on the center area of the uppermost surface of the laminated structure, and the mounted SAW filters 42 are connected to the laminated structure using the wire 44. Connection terminals of the high frequency composite component in accordance with the embodiment of the present invention comprise a connection terminal ANT for being connected to the antenna, a connection terminal Rx for being connected to the receiving unit of the first communication system, a connection terminal Tx for being connected to the transmitting unit of the first communication system and a connection terminal HF for being connected to the second communication system.

The protective sheet is made of metal, and the diplexer comprises inductors and capacitors formed of conductive patterns on a plurality of dielectric sheets of first and second laminated structures. The duplexer comprises two SAW filters individually connected to the transmitting and receiving units of the first communication system using the first frequency band, and one phase shifting device interposed between two SAW filters. The phase shifting device is formed of a conductive pattern on one dielectric sheet of the laminated structure. The SAW filters are mounted on an upper surface of a lower laminated structure defined by a cavity area formed on the center of the upper laminated structure. The SAW filters are connected to a signal line of the laminated structure by the wire bonding method. In order to easily form the wire bonding, the upper laminated structure preferably comprises the first laminated structure and the second laminated structure. The first laminated structure is mounted on the upper surface of the lower laminated structure, and comprises a first cavity for mounting the SAW filters. A conductive pattern for being wire-bonded to the SAW filters is formed on the uppermost dielectric sheet of the first laminated structure. The second laminated structure is mounted on the first laminated structure. Preferably, the second laminated structure comprises on its center a second cavity with a cross sectional area larger than that of the first cavity of the first laminated structure. A part of the conductive pattern formed on the uppermost dielectric sheet of the first laminated structure, i.e., an area of the conductive pattern for wire-bonding, is exposed through the second cavity of the second laminated structure, thereby easily wire-bonding the SAW filters to the first laminated structure.

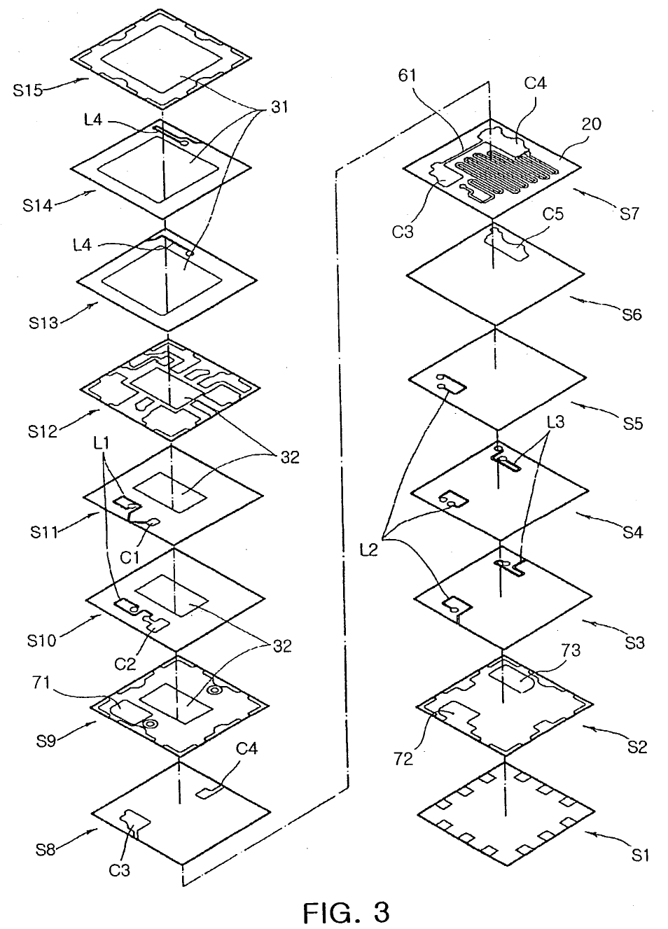

FIG. 3 is an exploded perspective view showing the laminated structure comprising individual dielectric sheets in accordance with an embodiment of the present invention. The laminated structure comprises the upper and lower laminated structures. The lower laminated structure comprises a first dielectric sheet S1 to an eighth dielectric sheet S8. The upper laminated structure comprises a ninth dielectric sheet S9 to a fifteenth dielectric sheet S15. More particularly, the upper laminated structure comprises the first laminated structure including the ninth dielectric sheet S9 to the twelfth dielectric sheet S12, and the second laminated structure including the thirteenth dielectric sheet S13 to the fifteenth dielectric sheet S15. A first cavity 32 for accommodating the SAW filters is formed in central portions a of individual dielectric sheets S9 to S12 of the first laminated structure. The conductive pattern for wire bonding the SAW filters is formed on the twelfth dielectric sheet S12, i.e., the uppermost dielectric sheet of the first laminated structure. A second cavity 31 is formed in individual dielectric sheets S13 to S15 of the second laminated structure and has a larger cross sectional area than that of the first cavity 32 so that the conductive pattern for wire bonding is exposed to the outside.

The diplexer comprises first to fifth capacitors C1 to C5, and first to fourth inductors L1 to L4. The first capacitor C1 is formed on the eleventh dielectric sheet S11, and the second capacitor C2 is formed on the tenth dielectric sheet S10. The third and fourth capacitors C3 and C4 are formed on the eighth dielectric sheet S8, and the fifth capacitor C5 is formed on the sixth dielectric sheet S6. The first inductor L1 is formed on the tenth and eleventh dielectric sheets S10 and S11, and the second inductor L2 is formed on the third to fifth dielectric sheets S3 to S5. The third inductor L3 is formed on the third and fourth dielectric sheets S3 and S4, and the fourth inductor L4 is formed on the thirteenth and fourteenth dielectric sheets S13 and S14.

Two SAW filters of the duplexer are mounted on the eighth dielectric sheet S8, i.e., the uppermost dielectric sheet of the lower laminated structure, and connected to the conductive pattern formed on the twelfth dielectric sheet S12, i.e., the uppermost dielectric sheet of the first laminated structure by the wire bonding method. The phase shifting device of the duplexer, i.e., a λ/4 strip line, is formed of a conductive pattern on the ninth dielectric sheet S9. The phase shifting device serves to prevent a signal transmitted by the transmitting unit from flowing into the receiving unit. Since the λ/4 strip line is very simple in its configuration and is easily formed of the conductive pattern, the λ/4 strip line is preferably used as the phase shifting device. However, the phase shifting device may be variously selected.

The above laminated structure of the dielectric sheets comprises a first frequency pass filter layer, a pair of ground sheets each having an open area and a second frequency pass filter layer laminated between the ground sheets and including capacitance elements formed of conductive patterns in positions corresponding to the open areas and at least one strip line for interconnecting the capacitance elements.

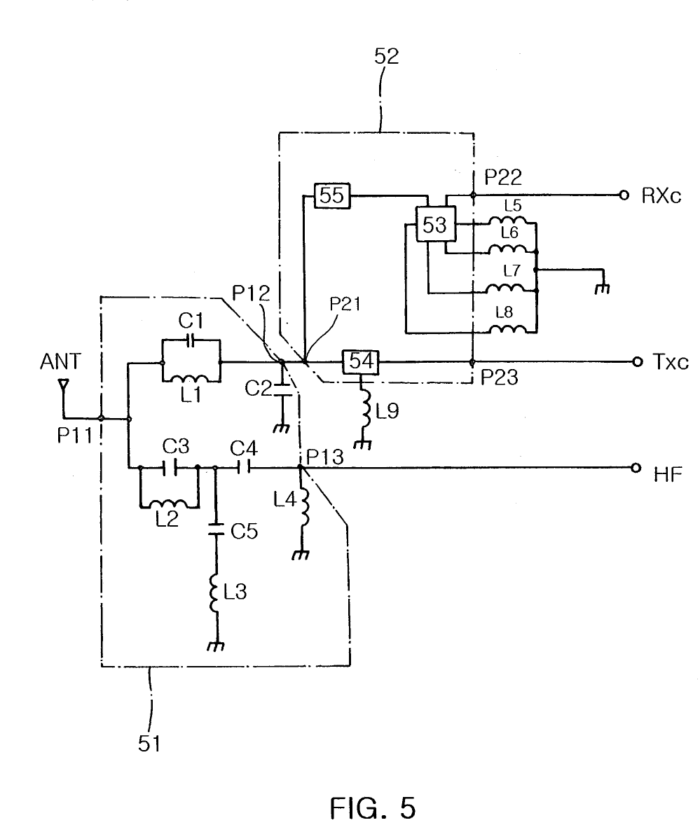

The first frequency pass filter layer is formed of the tenth and eleventh dielectric sheets S10 and S11 in FIG. 3 or a resonance circuit of the capacitors C1 and C2 and the inductor L1 of the diplexer 51 in FIG. 5. This first frequency pass filter layer preferably passes a frequency band in a range of approximately 824-894 MHz processed by the CDMA system.

The second frequency pass filter layer is formed of the third and eighth dielectric sheets S3 and S8 in FIG. 3 or the capacitors C3 to C5 and the inductors L2 to L4 of the diplexer 51 in FIG. 5. The second frequency band is in a range of approximately 1,570-1,580 MHz being used in the GPS system or in a range of approximately 1,850-1,990 MHz being used in the PCS system. The second frequency pass filter layer is disposed between the ground sheets S2 and S9.

In the diplexer formed of the above dielectric laminated structure, an interval between the upper and lower ground sheets S2 and S9 is smaller than a height of separate components of the prior art. Thus, a pattern designing technology is necessary to prevent interference between the grounding sheets and the upper and lower patterns.

The ground sheets S2 and S9 have open areas 71 to 73 free of the conductive patterns, as shown in FIG. 3, in order to solve such a problem of interference.

The ground sheets are disposed over and under the high pass filter layer. The ground sheets comprise the second and ninth dielectric sheets S2 and S9 in FIG. 3, in which the open areas 71 and 72 are formed in corresponding positions. The second dielectric sheet S2 further has the open area 73. The open areas 71 to 73 are formed to prevent interference with the patterns such as capacitances on the dielectric sheets of the first frequency pass filter layer, and thus capacitance and inductance elements are formed in areas of the dielectric sheets between the ground sheets corresponding to the open areas. Further, the ground sheet S9 is placed between the high pass filter layer and the low pass filter layer to divide the two filter layers.

In FIG. 4A, the high frequency composite component of the invention includes the connection terminal or signal port ANT for communicating a signal with the antenna and the connection terminal or signal port HF connected to the second communication system. The high frequency composite component further includes the connection terminals or signal ports Rx and Tx, in which the signal port Rx is connected to the receiving terminal of the first communication system and the signal port Tx is connected to the transmitting terminal of the first communication system. The signal port for the antenna is typically disposed opposite to the signal port for the second communication system to meet the requirements for the structure of a communication terminal.

When a received signal is transferred from the antenna to the second communication system in order to obtain a function of the second communication system such as a GPS receiver, the above construction increases a transmission distance of the signal, thereby creating signal loss. A strip line 61 in the seventh dielectric sheet S7 for example is used in order to solve the above problem.

In the seventh dielectric sheet S7 shown FIG. 3, the pattern forms the capacitor C3 connected to the antenna and the capacitor C5 connected to the GPS receiver. Since the antenna port ANT and the second communication signal port HF are placed opposite to each other, the capacitors C3 and C5 in the eighth dielectric sheet are spaced apart from each other. When the two capacitors are connected via the conventional conductive pattern, the two terminals have severe interference with the ground sheet of the ninth dielectric sheet S9. Although an open area can be formed on the ground sheet of the ninth dielectric sheet S9 corresponding to the conventional conductive pattern in order to solve the above problem, this may make the open area of the ground sheet too large, thereby deteriorating characteristics of grounding.

As another solution, a strip line set to an impedance of approximately 50 ohm can be connected between the two terminals to minimize interference of the terminals with the ground sheet and thus the loss between the terminals.

In the invention, the second frequency pass filter layer has the capacitance elements formed of the conductive patterns in positions corresponding to the open areas of the ground sheet. The second frequency pass filter also includes the strip line connecting the capacitance elements. The diplexer is formed of the above construction.

The capacitance elements of the second frequency pass filter layer include the first capacitance element C3 disposed adjacent to the signal port for the antenna and the second capacitance elements C4 and C5 disposed adjacent to the signal port for the second communication system. The strip line 61 connects the first capacitance element C3 to the second capacitance elements C4. This construction can reduce interference of the terminals with the ground sheet and thus signal loss in the composite component.

FIG. 5 is an equivalent circuit diagram of the high frequency composite component of the present invention. The diplexer 51 comprises a plurality of the inductors L1 to L4 and a plurality of the capacitors C1 to C5. The first inductor L1 is connected in parallel to the first capacitor C1 between the first and second ports P11 and P12 of the diplexer 51. The second port P12 of the diplexer 51 is grounded via the second capacitor C2. A circuit or a low-pass filter is formed between the first and second ports P11 and P12 of the diplexer 51, and passes through the first high frequency band, preferably a frequency band in a range of approximately 824 to 894 MHz processed by the CDMA system. The second inductor L2 and the third capacitor C3 are connected in parallel to each other to form a parallel circuit, which is connected in series to the fourth capacitor C4 between the first and third ports P11 and P13 of the diplexer 51. A connection portion between the parallel circuit of the second inductor L2 and the third capacitor C3 and the fourth capacitor C4 is grounded via a serial circuit having the fifth capacitor C5 and the third inductor L3. The third port P13 of the diplexer 51 is grounded via the fourth inductor L4. Those components between the first and third ports P11 and P13 of the diplexer 51 form a filter circuit or a high-pass filter for selectively passing a high frequency band. The duplexer 52 comprises two SAW filters 53 and 54 and the phase shifting device, i.e., the λ/4 strip line 55. The receiving SAW filter 53 and the λ/4 strip line 55 are disposed between the first and second ports P21 and P22 of the duplexer 52. The transmitting SAW filter 54 is disposed between the first and third ports P21 and P23 of the duplexer 52. The individual SAW filters 53 and 54 are grounded by the wire bonding. Wires each used in the wire bonding have an inductor element, and thus are formed of inductors L5 to L9 of the equivalent circuit diagram shown in FIG. 5.

As apparent from the above description, in accordance with the present invention, the high frequency composite component is formed of a single module comprising a diplexer and a duplexer within a front-end portion of a dual band mobile communication terminal, thereby reducing the number of components of the front-end portion of the mobile communication terminal. As a result, the matching circuits for connecting the components of the front-end portion are removed, thereby reducing insertion loss. This configuration of the high frequency composite component of the present invention does not require a larger space within the front-end portion of the mobile communication terminal, thereby satisfying the miniaturization of the mobile communication terminal.

Further, the present invention provides the structure of the dielectric sheets capable of preventing characteristics deterioration of the diplexer formed of the laminated dielectric sheets owing to arrangement and interference of the capacitance elements with the ground sheets where the diplexer and the duplexer are formed into the one composite module or the single component of. As a result, the excellent composite module structure can prevent signal loss therein.

Although the preferred embodiments of the present invention have been disclosed for illustrative purposes, those skilled in the art will appreciate that various modifications, additions and substitutions can be made without departing from the scope and spirit of the invention as disclosed in the accompanying claims.

What is claimed is:

1. A high frequency composite component for a front-end portion of a mobile communication terminal, which includes a first communication system passing through a first frequency band and a second communication system passing through a second frequency band higher than the first frequency band, said high frequency composite component comprising:
a Surface Acoustic Wave (SAW) duplexer connected to the first communication system and serving to divide signals into transmitting and receiving signals at the first frequency band; and
a diplexer connected to an antenna, the SAW duplexer and the second communication system, and serving to divide signals received from the antenna into signals at the first frequency band and signals at the second frequency band, to provide the divided signals respectively to the SAW duplexer and the second communication system, and to transfer signals provided by the SAW duplexer and transmitted from the first communication system and signals transmitted from the second communication system to the antenna.

2. The high frequency composite component as set forth in claim 1, wherein the first communication system is a CDMA system using a frequency band in a range of approximately 824-894 MHz, and the second communication system is a GPS system using a frequency band in a range of approximately 1,570-1,580 MHz or a PCS system using a frequency band in a range of approximately 1,850-1,990 MHz.

3. A laminated high frequency composite component for a front-end portion of a mobile communication terminal, which includes a first communication system for processing a first frequency band and a second communication system for processing a second frequency band higher than the first frequency band, said laminated high frequency composite component comprising:
a lower laminated structure formed by stacking a plurality of dielectric sheets;
an upper laminated structure having a cavity area in its center and formed on the lower laminated structure by stacking a plurality of dielectric sheets;
a diplexer formed of a conductive pattern on at least parts of the dielectric sheets of the lower and/or upper laminated structure;
a Surface Acoustic Wave (SAW) duplexer mounted on the upper surface of the lower laminated structure defined by the cavity area; and
a protective sheet formed on the upper surface of the upper laminated structure and serving to seal the cavity areas.

4. The laminated high frequency composite component as set forth in claim 3, wherein the first communication system is a CDMA system using a frequency band in a range of approximately 824-894 MHz, and the second communication system is a GPS system using a frequency band in a range of approximately 1,570-1,580 MHz or a PCS system using a frequency band in a range of approximately 1,850-1,990 MHz.

5. The laminated high frequency composite component as set forth in claim 3, wherein the protective sheet is made of metal.

6. The laminated high frequency composite component as set forth in claim 3, wherein the conductive pattern of the diplexer includes inductance elements and capacitance elements.

7. The laminated high frequency composite component as set forth in claim 3, wherein the SAW duplexer includes a transmitting SAW filter and a receiving SAW filter.

8. The laminated high frequency composite component as set forth in claim 7, wherein the SAW duplexer further includes a phase shifting device formed between the transmitting and receiving SAW filters.

9. The laminated high frequency composite component as set forth in claim 8, wherein the phase shifting device is a λ/4 strip line formed of a conductive pattern on one dielectric sheet of the upper or lower laminated structure.

10. The laminated high frequency composite component as set forth in claim 3, wherein the upper laminated structure includes a first laminated structure with a first cavity area having a designated size and a second laminated structure with a second cavity area having a larger size than that of the first cavity area,
wherein the SAW duplexer is connected to the conductive pattern formed on the upper surface of the first laminated structure and connected to the diplexer.

11. A laminated high frequency composite component for a front-end portion of a mobile communication terminal, which includes a first communication system for processing a first frequency band and a second communication system for processing a second frequency band higher than the first frequency band, said high frequency composite component comprising:
a lower laminated structure formed by stacking a plurality of dielectric sheets;
a first upper laminated structure formed on the lower laminated structure by stacking at least one dielectric sheet and having a first cavity area with a designated size on its center;
a second upper laminated structure formed on the first upper laminated structure by stacking at least one dielectric sheet having a second cavity area with a larger size than that of the first cavity area;
a diplexer formed of a conductive pattern on at least parts of the dielectric sheets of the lower laminated structure and/or the first and/or second upper laminated structures;
a Surface Acoustic Wave (SAW) duplexer mounted on the upper surface of the lower laminated structure defined by the second cavity area, connected to the diplexer via terminals formed on the upper surface of the first upper laminated structure defined by the first cavity area, and having a transmitting SAW filter and a receiving SAW filter;
a phase shifting device formed between the transmitting and receiving SAW filters on at least one dielectric sheet of the lower laminated structure or the first and second upper laminated structures; and
a protective sheet formed on the upper surface of the upper laminated structure and serving to seal the cavity areas.

12. A laminated high frequency composite component for a front-end portion of a mobile communication terminal, which includes a first communication system for processing a first frequency band and a second communication system for processing a second frequency band higher than the first frequency band, said high frequency composite component comprising:
a laminated structure having a plurality of laminated dielectric sheets with a cavity area on its center, the laminated dielectric sheets forming a diplexer and including a first frequency pass filter layer, a pair of ground sheets each having an open area, and a second frequency pass filter layer laminated between the ground sheets and having a plurality of capacitance elements formed of conductive patterns in positions corresponding to the open areas and at least one strip line for connecting the capacitance elements;
a Surface Acoustic Wave (SAW) duplexer mounted within the cavity area of the laminated structure; and
a protective sheet disposed on the laminated structure for sealing the cavity area.

13. The laminated high frequency composite component as set forth in claim 12, wherein the laminated structure includes a first signal port connected to an antenna and a second signal port connected to second communication system, wherein the first signal port for the antenna and the second signal port for the second communication system are formed on the opposite position to each other.

14. The laminated high frequency composite component as set forth in claim 13, wherein the capacitance elements of the second frequency pass filter layer includes a first capacitance element disposed adjacent to the signal port for the antenna and a second capacitance element disposed adjacent to the second communication system, wherein the strip line connects the first capacitance elements to the second capacitance elements.

15. The laminated high frequency composite component as set forth in claim 12, wherein the first communication system is a CDMA system using a frequency band in a range of approximately 824-894 MHz, and the second communication system is a GPS system using a frequency band in a range of approximately 1,570-1,580 MHz or a PCS system using a frequency band in a range of approximately 1,850-1,990 MHz.

16. The laminated high frequency composite component as set forth in claim 12, wherein the protective sheet is made of metal.

17. The laminated high frequency composite component as set forth in claim 12, wherein the SAW duplexer comprises a transmitting SAW filter and a receiving SAW filter.

18. The laminated high frequency composite component as set forth in claim 17, further comprising a phase shift device connected between the transmitting and receiving SAW filters.

19. The laminated high frequency composite component as set forth in claim 18, wherein the phase shifting device comprises a λ/4 strip line formed of a conductive pattern on one of the sheets of the laminated structure.
